(19) United States
(12) Patent Application Publication
(10) Pub. No.: US 2016/0101879 A1
(43) Pub. Date: Apr. 14, 2016

(54) Geostationary polar satellite

(71) Applicant: Michael Lewis Moravitz, Fairfax, VA (US)

(72) Inventor: Michael Lewis Moravitz, Fairfax, VA (US)

(21) Appl. No.: 14/121,692

(22) Filed: Oct. 9, 2014

(51) Int. Cl. B64G 1/10

(52) U.S. Cl. CPC B64G 1/1021; B64G 2001/1042

(57) ABSTRACT

A Satellite Stationary above the North or South Geometric Pole.

A satellite could be launched in a polar, or longitudinal orbit, in such a way as to be stationary above the geometric North or South Pole for research purposes.

Much more research needs to be done on climate change, its impact on the polar ice caps, the magnetic poles and how they shift, and the effects of solar wind on the ionosphere.

1) Builds on Patents for Geostationary Satellites, and

2) Polar Orbit Rocketry.
